(19) United States
(12) Patent Application Publication
(10) Pub. No.: US 2013/0103425 A1
(43) Pub. Date: Apr. 25, 2013

(54) IMAGING UTILITY SCORE

(71) Applicant: Mayo Foundation for Medical Education and Rese, Rochester, MN (US)

(72) Inventor: Paul R. Julsrud, Rochester, MN (US)

(73) Assignee: Mayo Foundation for Medical Education and Research, Rochester, MN (US)

(21) Appl. No.: 13/656,136

(22) Filed: Oct. 19, 2012

Related U.S. Application Data
(60) Provisional application No. 61/550,086, filed on Oct. 21, 2011.

(51) Int. Cl. G06Q 50/24

(52) U.S. Cl. 705/3

(57) ABSTRACT

An electronically based utility rating system and/or method measures the appropriateness of computerized physician order entry (CPOE) requests for medical imaging examinations. The so-called “imaging utility score” or simply, “u-score” may provide comparative data to help combat inappropriate medical imaging examinations, review resource utilization, and provide opportunities for medical education.

### CROSS REFERENCE TO RELATED APPLICATIONS

This application claims the benefit of U.S. provisional Application Ser. No. 61/550,086 filed Oct. 21, 2011, the entire contents of which is incorporated herein by reference.

### TECHNICAL FIELD

The disclosure relates generally to medical imaging examinations.

### BACKGROUND

Medical imaging technologies, such as computed tomography (CT) and magnetic resonance imaging (MRI), have vastly improved a physician's ability to detect and diagnose various conditions within the human body. For example, medical imaging is useful in the detection and diagnosis of cancer, fractures, tumors, degenerative joint disorders, heart disease, etc. However, not every scan ordered by a physician leads to an improved patient diagnosis or treatment. Some such scans may be considered inconclusive or redundant, or even unnecessary. Excessive use of medical imaging technologies may result in increased healthcare costs and expose patients to unnecessary doses of radiation.

### SUMMARY

In general, the disclosure is directed to review of requests for medical imaging examinations by determining the requests appropriateness based on an analysis of patient outcomes.

In one example, the disclosure is directed to a method comprising receiving imaging utility data, or “u-score” data, from each of a plurality of reviewers of a medical imaging procedure, the u-score data indicative of an opinion of the corresponding reviewer as to whether or not the medical imaging procedure had a positive effect or a negative effect, and analyzing the u-score data from each of the plurality of reviewers to determine whether the plurality of reviewers agree that the medical imaging procedure had a positive effect. Receiving u-score data may further include receiving an indication code, verification data, and an appropriateness criterion from each of the plurality of reviewers. Receiving the u-score data may further include receiving a u-score comprising one of a life saving u-score, a treatment plus u-score, a diagnostic u-score, a useful u-score, a questionable u-score, an unnecessary u-score, a misinformation u-score, a treatment minus u-score, and a major adverse effect u-score. The method may further comprise generating feedback to one or more of the reviewers based on the analysis. The method may further comprise randomly selecting medical imaging procedure requests to be reviewed.

In another example, the disclosure is directed to a system comprising a plurality of reviewer computing devices, each associated with at least one of a plurality of reviewers of a medical imaging procedure, and a server computer that receives u-score data from each of the plurality of reviewers, the u-score data indicative of an opinion of the corresponding reviewer as to whether or not the medical imaging procedure had a positive effect or a negative effect, and analyzes the u-score data from each of the plurality of reviewers to determine whether each of the plurality of reviewers agree that the medical imaging procedure had a positive effect. The server computer may further generate feedback to one or more of the reviewers based on the analysis.

The details of one or more examples are set forth in the accompanying drawings and the description below. Other features and advantages will be apparent from the description and drawings, and from the claims.

### BRIEF DESCRIPTION OF DRAWINGS

FIG. 1 is a flowchart illustrating an example process by which u-score data for a medical imaging examination may be entered, analyzed, and presented.

FIG. 2 shows an example u-score data entry form.

FIG. 3 shows an example indication code list for “Chest Pain.”

FIG. 4 shows an example source code list.

FIG. 5 is a chart showing example appropriateness criteria.

FIG. 6 is a diagram illustrating example u-score codes.

FIG. 7 is a block diagram illustrating an example medical imaging scoring system.

### DETAILED DESCRIPTION

The present disclosure describes an electronically based method to measure the appropriateness of computerized physician order entry (CPOE) requests for medical imaging examinations. The so-called “imaging utility score” or simply, “u-score” may provide comparative data to help combat inappropriate medical imaging examinations, review resource utilization, and provide opportunities for education via an auditing feedback mechanism, which may also provide for research opportunities. For example, the u-score system and method and the corresponding imaging utility data may be used to mitigate waste, fraud, and/or abuse on behalf of imaging examination ordering/performing physicians. Here, waste may include inappropriate ordering and performing an imaging procedure due to ignorance; fraud may include cheating the system by lying about why a procedure is necessary; and abuse may include ordering and performing an inappropriate imaging procedure, such as for financial gain, when a physician knows there likely would be no benefit to the patient. The educational, verification, and oversight aspects of the present disclosure may help to address each of these areas respectively. Other advantages of the present disclosure may include ensuring meaningful use of electronic medical records (EMRs), and the ability to generate outcomes analyses with peer review methodology from point of care electronic data.

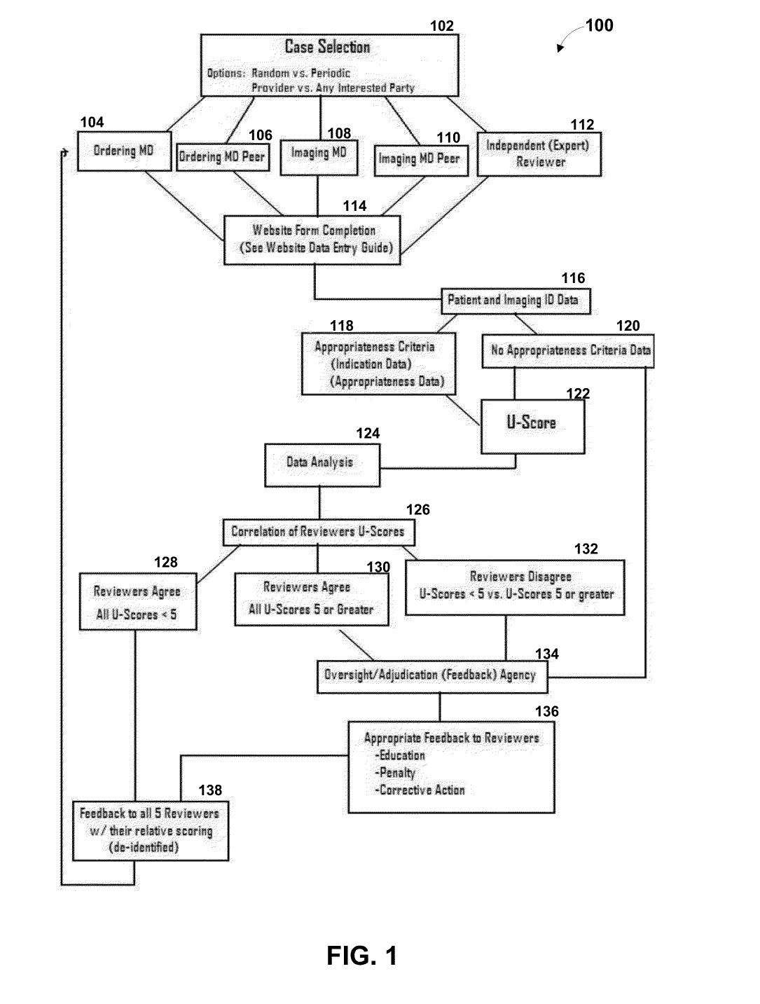

FIG. 1 is a flowchart illustrating an example process 100 by which u-score data for a medical imaging examination may be entered, analyzed, and presented. For a typical CPOE request for a medical imaging examination, an ordering physician electronically enters an order for the desired medical imaging procedure, such as computed tomography (CT), magnetic resonance imaging (MRI), and the like. These orders are communicated over a computer network to the medical staff or to the departments (e.g., radiology in this example) responsible for fulfilling the order. The test is performed and the results are stored in the patient's electronic medical record (EMR).

At the beginning of example process 100, a case is selected for review (102). The cases may be selected at random or they may be selected on a periodic basis. For example, every 5^{th} or 10^{th} case may be selected for review. In addition or alternatively, a case may be selected by the ordering physician, by the physician responsible for the exam, or by any interested party.

The case is then sent for imaging utility, or “u-score” review to several different reviewers. For example, the reviewers may include the ordering physician (104), a peer of the ordering physician (106), the physician who performed the imaging examination (108), a peer of the imaging physician (110), and/or an independent reviewer (112).

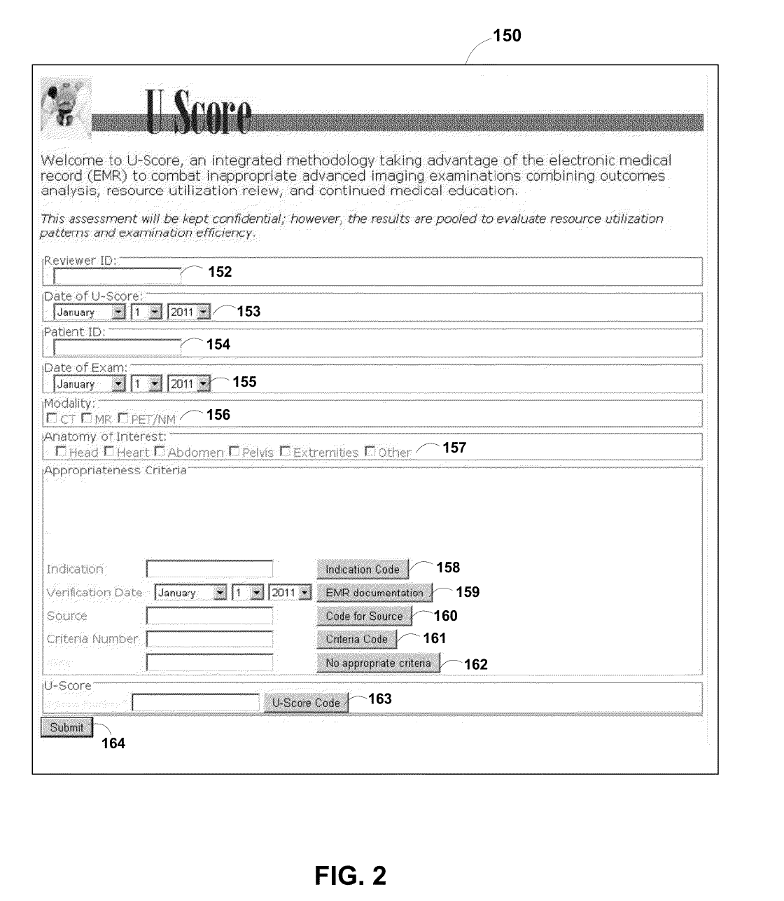

Each of the reviewers enters imaging utility data, or “u-score” data (114). For example, each reviewer may view and complete an electronic u-score form, such as the example u-score form 150 illustrated in FIG. 2. U-score form 150 may be presented via a web page, a software application, or other means for presented and obtaining information from a user. U-score form 150 includes a plurality of text boxes, pull-down menus, buttons, or other data entry interfaces into which the reviewer may enter u-score data. For example, the u-score form may permit a reviewer to enter a reviewer ID 152, the date of the u-score 153, a patient ID 154, and the date of the medical imaging examination 155. The reviewer may also enter the modality (e.g., CT, MR, PET/NM, etc.) of the medical imaging examination 156, as well as the anatomy of interest 157.

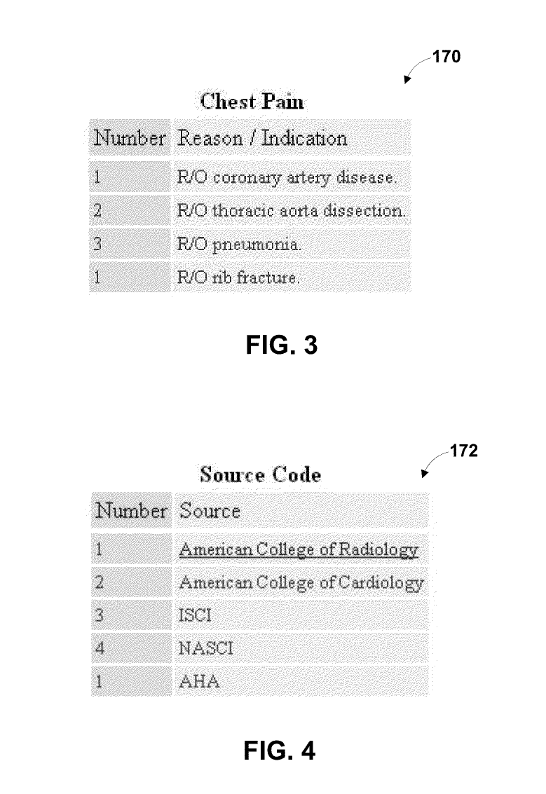

U-score form 150 may also permit the reviewer to enter the medical indication code for the imaging service; that is, the reason for performing the medical imaging procedure. For example, the reviewer may click on the “Indication Code” button 158, at which point a list of possible indication codes may be presented on the reviewers' electronic display. An example indication code list for “Chest Pain” is shown in FIG. 3.

U-score form 150 may also permit the reviewer to verify the ordering physician's indication and enter the verification date. The present u-score data may be integrated into or with the patient's electronic medical record (EMR) such that clicking the “EMR Documentation” button 159 may display a help text which provides additional guidance for the verification date, such as where this date can be found, or button 159 may link to where the verification date was recorded in the patient's EMR documentation. The “EMR Documentation” button 159 may also activate an automated routine which searches through the patient's EMR and provides the verification date automatically to the reviewer.

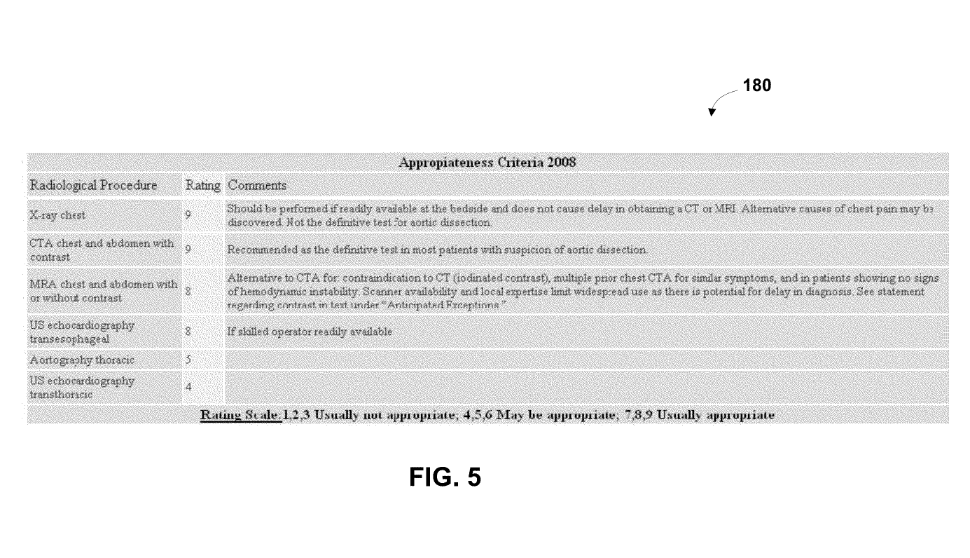

A list of possible sources for the appropriateness criteria used to fill out the “Criteria Number” may be obtained by clicking the “Code for Source” button 160. An example source code list 172 is shown in FIG. 4. The criteria number may be obtained by clicking the “Criteria Code” button 161 and entered in the “Criteria Number” text box or by clicking the appropriate criteria number from those presented in the list. Example appropriateness criteria are shown in FIG. 5. If there are no appropriate criteria, the reviewer may click on the “No appropriate criteria” button 162.

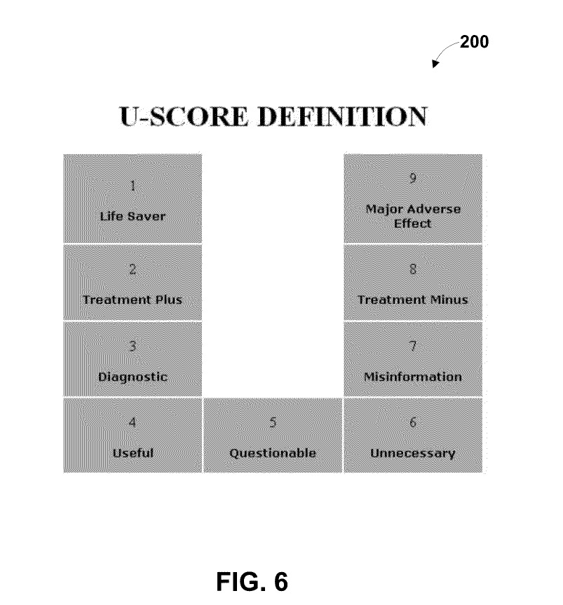

U-score form 150 also permits the reviewer to enter a u-score code 163. A list of possible u-score codes may be obtained by clicking on “U-Score Code” button 163. FIG. 6 is a diagram illustrating example u-score codes 200. In this example, the u-scores range from 1 to 9, where 1 indicates that the examination is likely responsible for dramatically improving patient outcome, 2 indicates the examination led to implementation of proper treatment, 3 indicates the examination was crucial to establishing the correct diagnosis, 4 indicates the examination was considered useful to managing the patient, 5 indicates the reviewer is unable to render an opinion or that assessment is to be deferred, 6 indicates the examination was probably unnecessary since it provided no useful information, 7 indicates the examination was misleading or resulted in delayed diagnosis, 8 indicates the examination resulted in erroneous information which led to inappropriate therapy, and 9 indicates that the examination is likely responsible for a major adverse effect on the patient, such as injury or death. It shall be understood, however, that other u-score ranges may be used, and that more or fewer possible u-scores may be presented, and that the disclosure is not limited in this respect. For example, the u-score may range from 1 to 3, where 1 indicates a major positive effect, 2 indicates a neutral result, and 3 indicates a major adverse effect. As another example, the u-score may range from 1 to 5, 1 to 20, 1 to 100, etc. As another example, the u-scores need not be numerical.

In the example u-score form 150, the reviewer enters the u-score code 163 and may click the “Submit” button 164 to submit their u-score review.

Referring again to FIG. 1, each of reviewers 104-112 completes their own u-score form (114), including the patient and imaging data (116), appropriate criteria and indication data (118), or if necessary indicates that no appropriateness criteria data (120) was available, and enters the u-score (122). The system may then analyze the u-score data from each of the reviewers (124). For example, the system may correlate the reviewers' u-scores (126) to determine that the reviewers either “agree” or “disagree” based on the u-score data. For example, the system may determine that the reviewers “agree” that the medical imaging request had a generally positive effect if all of the u-scores are less than 5 (128). The system may determine that the reviewers “agree” that the medical imaging request had a generally negative effect if all of the u-scores are greater than 5 (130). The system may determine that the u-scores “disagree” if some of the u-scores are less than 5 and some of the u-scores are greater than 5 (132). The system may send a report of the u-score data and the results of the analysis to an oversight body or agency for further review (134).

The system may also generate feedback to one or more reviewers (136). For example, the system may generate feedback for purposes of reviewer education. The system may also generate penalties or corrective action to one or more of the reviewers (e.g., the ordering physician) if upon analysis it appears that a particular ordering physician is making excessive or inappropriate use of medical imaging procedures. The feedback may be provided to one or more of the reviewers (138) with the reviewer identification removed for purposes of anonymity.

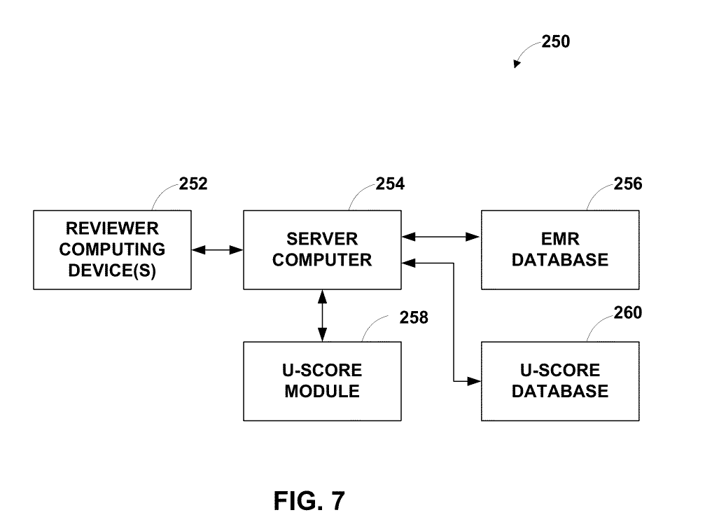

FIG. 7 is a block diagram illustrating an example medical imaging scoring system 250. The system includes one or more reviewer computing devices 252, a server computer 254 that executes a u-score module 258, and a u-score database 260. Server computer 254 may also be linked to or be integrated into an EMR database 256 in which electronic medical records for a plurality of patients are stored. At least some of the EMRs may include medical imaging data from one or more medical imaging tests.

U-score module 258 may be, for example, a software or firmware algorithm that, when executed by server computer 254 and/or reviewer computing device 252, accomplishes the u-score procedures described herein. For example, u-score module 258 may generate and present a u-score form (such as u-score form 150 of FIG. 2) on one or more reviewers' computing devices 252. U-score module 258 may also receive u-score data entered by one or more reviewers and analyze the u-score data for each case that undergoes u-score review.

The u-score data received for each case that undergoes u-score review may be stored in u-score database 260. The u-score module 258 may further generate and present feedback or reports based on the u-score data for each case and/or the analysis of the u-score data received from each review on a particular case that underwent u-score review. The u-score module 258 may further analyze u-score data associated with a plurality of cases that underwent u-score review. For example, u-score module 28 may perform outcomes analyses on u-score data associated with one or more of u-score reviews. U-score module 28 may further perform statistical analysis or other types of analysis on one or more of a plurality of u-score reviews. U-score module 28 may further generate reports presenting the results of the analysis. The u-score procedure may help to quantify the effectiveness of the medical imaging services ordered by a particular health care provider. The u-score procedure may provide a sentinel effect that leads to a decrease in inappropriate testing and also reduce imaging resource utilization.

In some examples, the u-score systems and/or methods described herein may encompass one or more computer-readable media comprising instructions that cause a processor, such as processor 42, to carry out the methods described above. A “computer-readable medium” includes but is not limited to read-only memory (ROM), random access memory (RAM), non-volatile random access memory (NVRAM), electrically erasable programmable read-only memory (EEPROM), flash memory a magnetic hard drive, a magnetic disk or a magnetic tape, a optical disk or magneto-optic disk, a holographic medium, or the like. The instructions may be implemented as one or more software modules, which may be executed by themselves or in combination with other software. A “computer-readable medium” may also comprise a carrier wave modulated or encoded to transfer the instructions over a transmission line or a wireless communication channel. Computer-readable media may be described as “non-transitory” when configured to store data in a physical, tangible element, as opposed to a transient communication medium. Thus, non-transitory computer-readable media should be understood to include media similar to the tangible media described above, as opposed to carrier waves or data transmitted over a transmission line or wireless communication channel.

The instructions and the media are not necessarily associated with any particular computer or other apparatus, but may be carried out by various general-purpose or specialized machines. The instructions may be distributed among two or more media and may be executed by two or more machines. The machines may be coupled to one another directly, or may be coupled through a network, such as a local access network (LAN), or a global network such as the Internet.

The u-score systems and/or methods may also be embodied as one or more devices that include logic circuitry to carry out the functions or methods as described herein. The logic circuitry may include a processor that may be programmable for a general purpose or may be dedicated, such as microcontroller, a microprocessor, a Digital Signal Processor (DSP), an Application Specific Integrated Circuit (ASIC), a field programmable gate array (FPGA), and the like.

One or more of the techniques described herein may be partially or wholly executed in software. For example, a computer-readable medium may store or otherwise comprise computer-readable instructions, i.e., program code that can be executed by a processor to carry out one of more of the techniques described above. A processor for executing such instructions may be implemented in hardware, e.g., as one or more hardware based central processing units or other logic circuitry as described above.

Various examples have been described. These and other examples are within the scope of the following claims.

1. A method comprising:
receiving, by a computing device, utility rating data from each of a plurality of reviewers of a medical imaging procedure, the utility rating data indicative of an opinion of the corresponding reviewer as to whether or not the medical imaging procedure had a positive effect or a negative effect; and
analyzing, by the computing device, the utility rating data from each of the plurality of reviewers to determine whether the plurality of reviewers agree that the medical imaging procedure had a positive effect.

2. The method of claim 1 wherein receiving utility rating data further includes receiving an indication code and an appropriateness criterion from each of the plurality of reviewers.

3. The method of claim 1 wherein receiving the utility rating data further includes receiving a utility rating comprising one of a life saving utility rating, a treatment plus utility rating, a diagnostic utility rating, a useful utility rating, a questionable utility rating, an unnecessary utility rating, a misinformation utility rating, a treatment minus utility rating and a major adverse effect utility rating.

4. The method of claim 1 further comprising generating feedback to one or more of the reviewers based on the analysis.

5. The method of claim 1 further comprising randomly selecting medical imaging procedure requests to be reviewed.

6. The method of claim 1 further comprising storing utility rating data associated with a plurality of medical imaging procedures in an electronic medical records database.

7. The method of claim 1 further comprising storing utility rating data associated with a plurality of medical imaging procedures in a utility rating database.

8. The method of claim 1 further comprising receiving utility rating data associated with each of a plurality of medical imaging procedures.

9. The method of claim 1 further comprising performing an outcomes analyses on the utility rating data associated with one or more of the plurality of medical imaging procedures.

10. A system comprising:
a plurality of reviewer computing devices, each associated with at least one of a plurality of reviewers of a medical imaging procedure; and
a server computer that receives utility rating data from each of the plurality of reviewers, the utility rating data indicative of an opinion of the corresponding reviewer as to whether or not the medical imaging procedure had a positive effect or a negative effect, and analyzes the utility rating data from each of the plurality of reviewers to determine whether each of the plurality of reviewers agree that the medical imaging procedure had a positive effect.

11. The system of claim 10 wherein the server computer further generates feedback to one or more of the reviewers based on the analysis.

12. The system of claim 10 further comprising an electronic medical records database accessible by the server computer.

13. The system of claim 12 wherein the server computer provides at least one of the plurality of reviewers with access to data in the electronic medical records database.

14. The system of claim 12 wherein the electronic medical records database stores utility rating data associated with a plurality of medical imaging procedures.

15. The system of claim 10 further comprising a utility rating database that stores utility rating data associated with a plurality of medical imaging procedures.

16. The system of claim 10 wherein the server computer further performs an outcomes analyses on the utility rating data associated with one or more of the plurality of medical imaging procedures.

17. The system of claim 10 wherein the utility rating data further includes an indication code and an appropriateness criterion from each of the plurality of reviewers.

18. The system of claim 10 wherein the utility rating data further includes one of a life saving utility rating, a treatment plus utility rating, a diagnostic utility rating, a useful utility rating, a questionable utility rating, an unnecessary utility rating, a misinformation utility rating, a treatment minus utility rating and a major adverse effect utility rating.
